(19) United States
(12) Patent Application Publication
(10) Pub. No.: US 2016/0226086 A1
(43) Pub. Date: Aug. 4, 2016

(54) COLLECTING TANK, PARTICULARLY FOR A POTENTIALLY FLAMMABLE AND/OR EXPLOSIVE ENVIRONMENT

(71) Applicants: Robert Adler, Gerasdorf (AT); Ekkehardt Klein, Katzelsdorf (AT); Christoph Nagl, Alland (AT); Andreas Pollak, Wien (AT); Werner Muchitsch, Maria Enzersdorf (AT)

(72) Inventors: Robert Adler, Gerasdorf (AT); Ekkehardt Klein, Katzelsdorf (AT); Christoph Nagl, Alland (AT); Andreas Pollak, Wien (AT); Werner Muchitsch, Maria Enzersdorf (AT)

(21) Appl. No.: 15/008,479

(22) Filed: Jan. 28, 2016

(30) Foreign Application Priority Data
Jan. 29, 2015 (DE) DE 102015001108.1

(51) Int. Cl. H01M 8/04082; B60L 11/18; F17C 7/00; F17C 13/12; F17C 5/00

(52) U.S. Cl. CPC H01M 8/04201; F17C 13/12; F17C 5/00; F17C 7/00; B60L 11/1883; F17C 2221/012; F17C 2227/045; F17C 2260/042; H01M 2250/20

(57) ABSTRACT

A collecting tank, for a potentially flammable or explosive environment, includes: a collecting chamber for fluid having a condensate inlet; and a suction opening for extracting fluid. The tank also includes: a Venturi nozzle fluidically connected to the suction opening to generate a vacuum in the suction opening; a pressure medium inlet fluidically connected upstream of the Venturi nozzle to generate a vacuum in the suction opening when pressure medium is introduced into the Venturi nozzle; and an extraction outlet fluidically connected downstream of the Venturi nozzle and to the suction opening, for extracting fluid from the collecting chamber. Methods of operation for the collecting tank and a hydrogen-powered vehicle utilizing the collecting tank are also described.

The invention pertains to a collecting tank, particularly for a potentially flammable or explosive environment, a method for evacuating such a collecting tank, as well as a hydrogen-powered vehicle.

Condensates accumulate in numerous potentially flammable or explosive, environments of a process and should be collected in order to respectively prevent the environment from being soiled or compromised or to make the condensate available as raw material for other processes. For example, electric floor-borne vehicles with fuel cells are increasingly utilized, wherein these fuel cells are preferably fueled with hydrogen (H₂) and driving energy is conventionally generated from hydrogen with oxygen in the fuel cell, and wherein water is produced during this process. Due to the risk of accidents and potential soiling, which should be avoided, the accumulating water should not reach the ground and is collected in collecting tanks. Another exemplary problem is condensation drying, for example, of natural gas, in which a condensate consisting of a mixture of water, ligroin and benzene is accumulated. This mixture is highly flammable and highly explosive, it is categorized as an Ex-Zone 0 (explosion protection zone stage 0). A hydrogen-powered vehicle or its collecting tank is respectively categorized as an Ex-Zone 2. Mechanical equipment is subject to special requirements in both these explosion protection zones. In floor-borne vehicles, suction pumps with ATEX certification (according to European ATEX Worker Protection Directive 1999/92/EG; ATEX—atmospheres explosibles) and with the protection against dry running are currently utilized. This means that the device is not only expensive, but the collecting tank also cannot be pumped completely empty in order to prevent damages to the suction pump, Virtually no pumps exist for an Ex-Zone 0.

Based on these circumstances, the present invention aims to at least partially overcome the disadvantages of the prior art. The characteristics of the invention can be combined in any technically feasible manner, namely also by consulting the explanations in the following description and characteristics of the figures, which comprise supplementary embodiments of the invention.

According to an aspect of the invention, the above-defined objective is attained by developing a collecting tank, particularly for a potentially flammable or explosive environment, which features at least the following components:
a collecting chamber for accommodating a fluid to be collected with a condensate inlet for the fluid;
a suction opening for extracting the fluid from the collecting chamber.

The collecting tank is especially characterized in that at least the following components are additionally provided:
a Venturi nozzle that is fluidically connected to the suction opening such that a vacuum can be generated in the suction opening due to a vacuum generated in the Venturi nuzzle;
a pressure medium inlet for a pressure medium that is arranged upstream of the Venturi nozzle and fluidically connected to the Venturi nozzle such that a vacuum is generated in the suction opening when a pressure medium is introduced into the Venturi nozzle via the pressure medium inlet and flows through the Venturi nozzle (particularly past the suction opening);
an extraction outlet that is arranged downstream of the Venturi nozzle and fluidically connected to the Venturi nozzle, as well as to the suction opening, and serves for extracting the fluid from the collecting chamber.

The proposed collecting tank is suitable for mobile applications, as well as for stationary applications, and designed for collecting a (preferably partially liquid) medium accumulated, for example, as condensate or waste product in a process. For example, the collecting tank is a condensate tank for a fuel cell-powered vehicle or for a condensation process. The device for collecting the fluid is a collecting chamber that is preferably closed on all sides, but may also be open on the top, for example similar to a pot. Due to the superior leakage protection, the closed design is particularly advantageous for mobile applications, as well as for hazardous materials in order to prevent the condensate from volatilizing in the form of a (flammable or explosive) air-gas mixture.

A suction opening is provided the collecting chamber and may be realized the form of an opening in a wall of the collecting chamber or extend, for example, in the form of a hose or conduit from an upper section of the collecting chamber referred to Earth's gravitational field into a lower section that preferably lies near the lowest point of the collecting chamber. The suction opening is fluidically connected to a Venturi nozzle, wherein the suction opening is preferably arranged laterally of a flow channel of the Venturi nozzle, namely in the region of the narrowest point, particularly at the narrowest point of the cross section of the Venturi nozzle or the flow channel, respectively. In this way, a vacuum is respectively generated in the conduit leading to the suction opening or at the suction opening (e.g. if no conduit is provided) when a fluid or the pressure medium respectively flows through the Venturi nozzle.

Venturi nozzles are known from the prior art and primarily characterized by a cross-sectional constriction and, in particular, an adjacent cross-sectional widening of its flow channel (e.g. a tube section) such that the pressure medium or fluid, typically a gas (such as, e.g., compressed air), flowing through the Venturi nozzle is accelerated in the region of the narrowest cross section of the flow channel and a vacuum is accordingly generated. The suction opening preferably leads into this vacuum region in the flow channel. Furthermore, a pressure medium inlet is provided, by means of which a pressure medium source can be connected to the Venturi nozzle, such that a pressure medium (preferably compressed air) can he respectively introduced into the Venturi nozzle and into the flow channel. The pressure medium inlet may be realized in the form of a standardized compressed air connector of the type used in many manufacturing sectors. However, it is also possible to use other pressure mediums such as, for example, (pressurized) water, wherein it is preferred to use a (harmless) gas, such as nitrogen, that does not have to be collected, but rather can he discharged into the surroundings.

A plurality of Venturi nozzles are preferably provided, wherein the Venturi nozzles are preferably connected in parallel. In this case, the individual pressure medium inlets are combined into a main inlet that branches out to the individual pressure medium inlets of the individual Venturi nozzles and respectively are fluidically connected thereto. The outlets of the individual Venturi nozzles are combined into a main outlet, through which the pressure medium can be discharged together with the fluid.

Due to the Venturi nozzle, the fluid can be vacuum-extracted without requiring mechanical components for this purpose in the region of the collecting chamber (hazard zone). i.e. components with a relative motion generating heat that could potentially trigger a combustion or explosion.

In addition, the Venturi nozzle functions irrespective of the fluid to be vacuum-extracted such that protection against dry running is not required. Consequently, such a collecting tank can even be used in an Ex-Zone 0, but also in other areas, for example, in which compressed air is available as particularly suitable evacuating mechanism.

According to another advantageous embodiment of the collecting tank, a pneumatic valve is provided for opening/closing the pressure medium inlet.

According to another aspect of the invention, a method for evacuating a collecting, tank is proposed, particularly in a potentially flammable or explosive environment, wherein a pressure medium is introduced into the Venturi nozzle of an inventive collecting tank via the pressure medium inlet, and wherein the fluid is vacuum-extracted from the collecting tank through the Venturi nozzle via the suction opening and discharged via the extraction outlet together with the pressure medium. The pressure medium preferably consists of compressed air.

The method is primarily characterized in that it can be used in an Ex-Zone 0 because no friction-generating, mechanical parts are provided in the region of the Ex-Zone. It is furthermore not necessary to respectively provide protection against dry running or a process for protecting against dry running. In the inventive method, the pressure medium is routed, in particular, through the flow channel of the Venturi nozzle, namely past the suction opening, wherein a vacuum is respectively generated in the region of the suction opening or in a fluidic connection of the collecting chamber to the suction opening. In this way, the fluid (e.g. water) is vacuum-extracted from the collecting tank via the suction opening and discharged together with the pressure medium via the extraction outlet.

According to another advantageous embodiment of the method, the vacuum extraction is stopped after at least one of the following conditions is fulfilled:
reaching a predefined time period of the vacuum extraction after starting the operation of the Venturi nozzle,
completing another process, preferably a fueling process;
reaching a predefined fluid quantity to be extracted.

According to another advantageous embodiment of the method, at least one mobile hydrogen reservoir is filled with hydrogen simultaneously with the evacuation of the collecting tank. In this preferred embodiment, the vacuum extraction of the fluid is combined with a fueling process of the hydrogen reservoir such that no additional expenditure of time is incurred for the extraction from the collecting tank. It is particularly preferred to use a common fueling device for this purpose, wherein said fueling device comprises the corresponding connectors for a fueling process, a pressure medium supply and a fluid extraction such that no additional manipulations are required for evacuating the collecting tank simultaneously with filling the hydrogen reservoir.

According to another aspect of the invention, a hydrogen-powered vehicle featuring at least the following components is disclosed:
a hydrogen reservoir for storing hydrogen;
a reactor, particularly in the form of a fuel cell, for generating driving energy for the vehicle by using hydrogen and oxygen and simultaneously producing water; and an inventive collecting tank for collecting the water being produced.

The invention particularly proposes a hydrogen-powered vehicle, preferably a floor-borne vehicle (e.g. a forklift) featuring a fuel cell, wherein the accumulating water is advantageously captured in a collecting tank such that the vehicle or floor-borne vehicle respectively does not discharge any water that could lead to reduced wheel grip and/or soiling of the floor, The collecting tank is particularly realized in accordance with one of the above-described embodiments. Furthermore, an inventive method for evacuating the collecting tank can he carried out, particularly irrespective of a filling level of the collecting tank.

It is particularly preferred to carry out the evacuation of the collecting tank during a fueling process of the vehicle by utilizing a common fueling device according to the preceding description, in which filling of the hydrogen reservoir with hydrogen is simultaneously combined with evacuating the collecting tank.

The inventive principle of a vacuum extraction with the aid of Venturi nozzles can also be applied to the evacuation of collecting tanks for combustible fluids.

This applies, in particular, to the extraction of a condensate consisting of a mixture of water, ligroin and benzene that accumulates in a collecting tank during a condensation drying process of natural gas. This is typically categorized as an Ex-Zone 0 such that the inventive method and the inventive device can be advantageously utilized in this case.

The above-described invention is elucidated in greater detail below with reference to the associated drawings that show preferred embodiments of the invention. In these drawings,

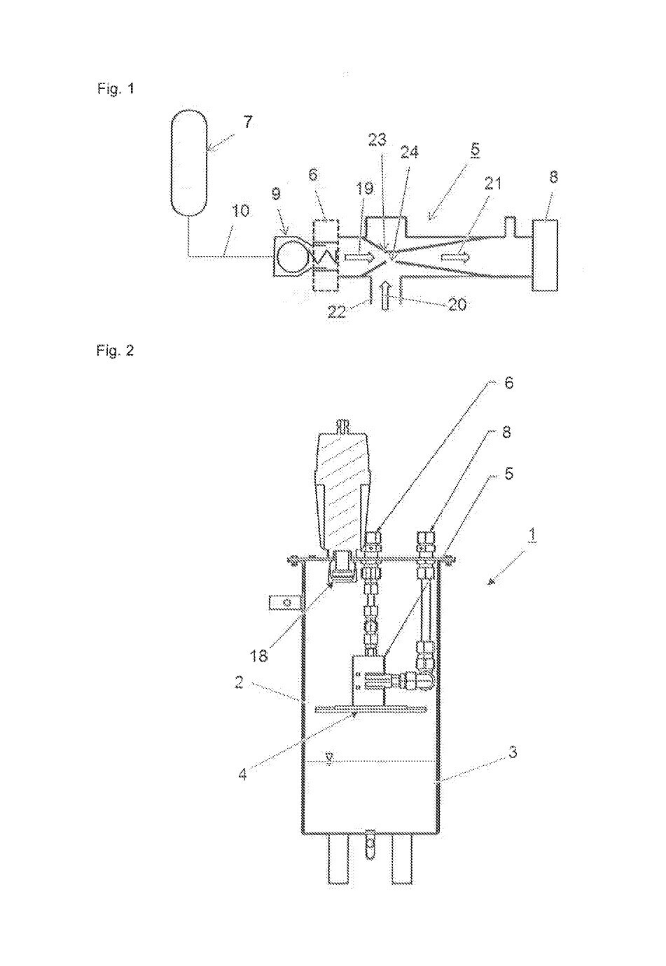

FIG. 1 shows a Venturi nozzle with connected pressure medium source;

FIG. 2 shows a collecting tank with Venturi nozzle;

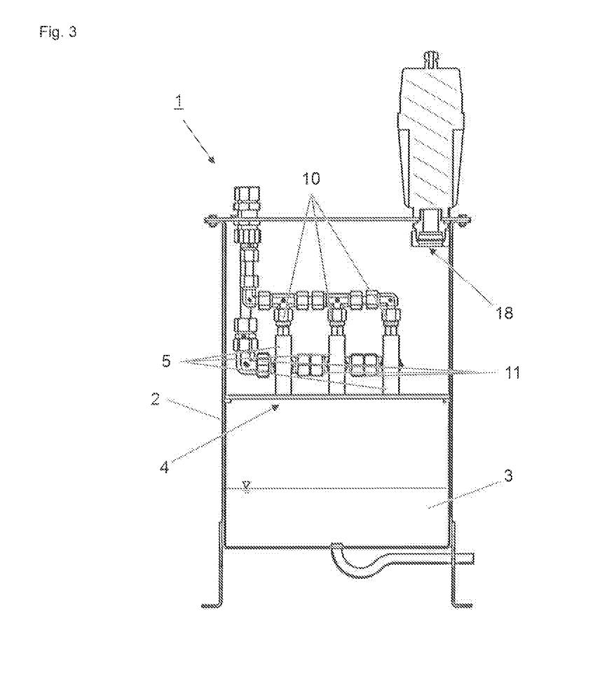

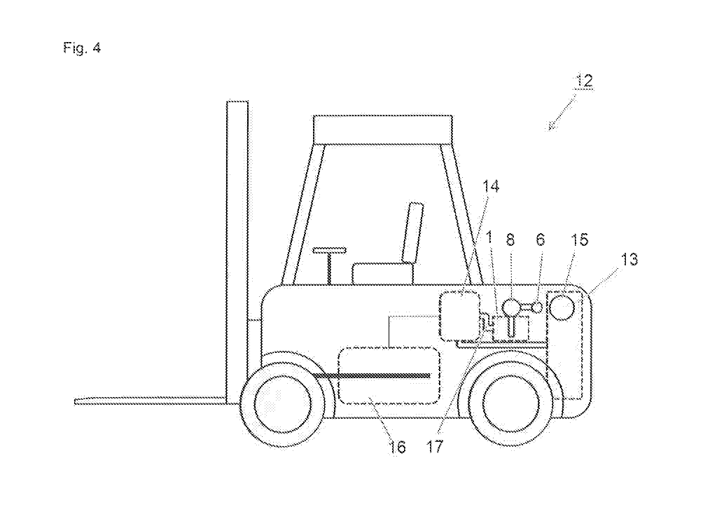

FIG. 3 shows a collecting tank with a plurality of Venturi nozzles; and

FIG. 4 shows a hydrogen-powered vehicle.

FIG. 1 shows a Venturi nozzle 5 that is fluidically connected to a pressure medium source 7. A pressure medium conduit 10 is connected to a pressure medium inlet 6 by means of a pneumatic valve 9, which is opened in this case by means of a schematically illustrated spring device of the pressure medium inlet 6. A pressure medium 19, particularly compressed air, therefore is introduced into the Venturi nozzle 5 in this state. The Venturi nozzle 5 features a flow channel with a constriction 23, wherein a suction opening 24 laterally leads into the flow channel and into the Venturi nozzle 5 in the region of the constriction 23. A vacuum is generated at the suction opening 24 due to the acceleration of the pressure medium flow 19 caused by the constriction 23. This vacuum leads to a fluid flow 20 of a fluid to he extracted, which enters the Venturi nozzle 5, in particular, via the connected suction conduit 22, as well as the suction opening 24. The mixture 21 of the pressure medium and the fluid to be vacuum-extracted is respectively discharged from the Venturi nozzle 5 and the collecting tank 1 (see FIG. 2) via an extraction outlet 8.

FIG. 2 shows an inventive collecting tank 1 with a Venturi nozzle 5, particularly according to FIG. 1, and with a collecting chamber 2, in which a fluid 3 to be vacuum-extracted has accumulated in the bottom region. The fluid 3 is arranged underneath the suction opening 4 such that (at least partial) dry running occurs in this case during an extraction process. The collecting chamber 2 has a closed design in this case and features a condensate inlet 18, through the condensate such as, for example, water enters the collecting chamber. The Venturi nozzle 5 is fluidically connected to a pressure medium inlet 6 such that the fluid can be discharged via the suction opening 4. The suction opening 4 is fluidically connected to an extraction outlet 8 such that the extracted condensate-pressure medium mixture can be discharged,

FIG. 3 shows a collecting tank 1 with three Venturi nozzles 5 and with a collecting chamber 2. This view of the collecting tank 1 is preferably turned by 90° as illustrated in FIG. 2. In this case, the Venturi nozzles 5 are connected in parallel, as well as to a common pressure medium conduit 10 that branches out to the individual Venturi nozzles 5. The Venturi nozzles 5 preferably lead into a common suction conduit 11, through which the condensate is discharged together with the pressure medium.

FIG. 4 shows a hydrogen-powered vehicle 12 such as, for example, a floor-borne vehicle in the form of a forklift that features a hydrogen reservoir 13, a reactor 14 such as, for example, a fuel cell, a collecting tank 1 and a power plant 16. The collecting tank 1 is connected to the reactor 14 via a condensate discharge conduit 17 in order to receive condensate being produced and an external hydrogen connector 15, pressure medium connector 6 and extraction connector 8 are respectively provided.

The proposed collecting tank and the method for evacuating a collecting tank allow the extraction of accumulated condensate with a simple design that can be easily handled and advantageously utilized in an Ex-Zone 0.

1. A collecting tank comprising:
a collecting chamber for accommodating a fluid to be collected with a condensate inlet for the fluid; and
a suction opening, for extracting the fluid from the collecting chamber; characterized by
a Venturi nozzle that is fluidically connected to the suction opening such that a vacuum can be generated in the suction opening due to a vacuum generated in the Venturi nozzle;
a pressure medium inlet for a pressure medium that is arranged upstream of the Venturi nozzle and fluidically connected to the Venturi nozzle such that a vacuum can be generated in the suction opening when a pressure medium is introduced into the Venturi nozzle via the pressure medium inlet; and
an extraction outlet that is arranged downstream of the Venturi nozzle and fluidically connected to the Venturi nozzle, as well as to the suction opening, such that the fluid can be extracted from the collecting chamber via the extraction outlet.

2. The collecting tank according to claim 1, the collecting tank being for use in a potentially flammable or explosive environment.

3. The collecting tank according to claim 1, characterized in that a pneumatic valve is provided for closing the pressure medium inlet.

4. A method for evacuating a collecting tank,
the collecting tank comprising;
a collecting chamber for accommodating a fluid to be collected with a condensate inlet for the fluid;
a suction opening for extracting the fluid from the collecting chamber;
a Venturi nozzle that s fluidically connected to the suction opening suction opening such that a vacuum can be generated in the suction opening due to a vacuum generated in the Venturi nozzle;
a pressure medium inlet for a pressure medium that is arranged upstream of the Venturi nozzle and fluidically connected to the Venturi nozzle such that a vacuum can he generated in the suction opening when a pressure medium is introduced into the Venturi nozzle via the pressure medium inlet; and an extraction outlet that is arranged downstream of the Venturi nozzle and fluidically connected to the Venturi nozzle, as well as to the suction opening, such that the fluid can be extracted from the collecting chamber via the extraction outlet;
the method comprising:
introducing pressure medium into the Venturi nozzle of the collecting tank via the pressure medium inlet;
vacuum extracting the fluid from the collecting tank through the Venturi nozzle via the suction opening; and
discharging the fluid via the extraction outlet together with the pressure medium.

5. The method according to claim 4, the collecting tank being for use in a potentially flammable or explosive environment.

6. The method according to claim 4, characterized in that the vacuum extraction is stopped after at least one of the following conditions is fulfilled:
reaching a predefined time period of the vacuum extraction after starting the operation of the Venturi nozzle;
completing another process, preferably a fueling, process; or
reaching a predefined fluid quantity to be extracted.

7. The method according to claim 6, wherein completing another process is completing a fueling process.

8. The method according to claim 4 further comprising:
filling a hydrogen reservoir with hydrogen simultaneously with the evacuation of the collecting tank.

9. The method according to claim 8, wherein the hydrogen reservoir is a mobile hydrogen reservoir.

10. The method according to claim 8, wherein the hydrogen reservoir is a hydrogen reservoir of a hydrogen-powered vehicle.

11. A hydrogen-powered vehicle, including:
a hydrogen reservoir;
a reactor, for generating driving energy for the vehicle by using hydrogen and oxygen and simultaneously producing water; and
a collecting tank according for the water being produced, the collecting tank comprising;
a collecting chamber for accommodating a fluid to be collected with a condensate inlet for the fluid;
a suction opening for extracting the fluid from the collecting chamber;
a Venturi nozzle that is fluidically connected to the suction opening such that a vacuum can be generated in the suction opening due to a vacuum generated in the Venturi nozzle;
a pressure medium inlet for a pressure medium that is arranged upstream of the Venturi nozzle and fluidically connected to the Venturi nozzle such that a vacuum can be generated in the suction opening when a pressure medium is introduced into the Venturi nozzle via the pressure medium inlet; and
an extraction outlet that is arranged downstream of the Venturi nozzle and fluidically connected to the Venturi nozzle, as well as to the suction opening, such that the fluid can he extracted from the collecting chamber via the extraction outlet.

12. The hydrogen-powered vehicle according to claim 11, wherein the reactor is a fuel cell.
